(19) United States
(12) Patent Application Publication
(10) Pub. No.: US 2005/0032241 A1
(43) Pub. Date: Feb. 10, 2005

(54) Reagent dispenser and dispensing method

(76) Inventors: Peter J. Coassin, Encinitas, CA (US); Javier Flores, Bonita, CA (US); David Nicol, Anaheim, CA (US); Troy Peterson, Poway, CA (US); Philip Salzmann, Cardiff, CA (US); T. Minh Vuong, San Diego, CA (US)

Correspondence Address: GRAY CARY WARE & FREIDENRICH LLP, 4365 EXECUTIVE DRIVE, SUITE 1100, SAN DIEGO, CA, 92121-2133, US

(21) Appl. No.: 10/789,183

(22) Filed: Feb. 26, 2004

Related U.S. Application Data
(60) Provisional application No. 60/450,066, filed on Feb. 26, 2003.

(51) Int. Cl. B01L 3/02

(52) U.S. Cl. 436/180; 422/100

(57) ABSTRACT

A method and apparatus is disclosed for automated on-the-fly dispensing of reagents. The apparatus includes a detachable reagent dispensing module supported by a support frame. The dispensing module includes a self-contained pressurized fluid delivery subsystem that facilitates efficient attachment and detachment of the module, including pressurized reagent containers and associated accessories arranged such that each reagent container has a discrete fluid path terminating at a corresponding discrete reagent dispensing tip. The dispensing tips are supported in a common dispensing head, and are arranged geometrically such that the centers of the dispensing tips are separated by distances corresponding to relevant dimensions of particular assay plates to be used therewith. Such a geometric arrangement allows for dispensing of multiple reagents substantially simultaneously into multiple corresponding target wells of the assay plate, efficiently and precisely.

### INCORPORATION BY REFERENCE

This application claims the benefit of U.S. Provisional Application No. 60/450,066 filed Feb. 26, 2003, the contents of which are incorporated by reference.

### BACKGROUND OF THE INVENTION

1. Field of the Invention

The present invention relates generally to a method and apparatus for dispensing reagents and other liquids. More particularly, the present invention relates to a method and apparatus for delivering multiple reagents into an assay plate or other receptacle.

2. Description of the Related Art

Many areas of scientific and medical research require dispensing reagents (any chemical or biological material that is a part of an assay) into assay plates. For example, medical diagnosis of and deciding upon a course of treatment for various diseases include the mixing of specific reagents with various bodily fluids in order to detect the presence or absence of a particular viral, bacterial, or other infectious constituent. Biological research may involve the addition of a particular chemical substance to cells in order to determine certain intercellular binding characteristics. In addition, pharmaceutical companies may perform extensive drug screening processes in which a drug is dispensed as part of a series of chemical assays in order to identify possible adverse reactions in humans or other species. In each of the aforementioned examples, the chemical interaction between the reagents may be quite sensitive, and the testing or screening procedures involve a very large number of discrete reactions.

In order to obtain the most useful data, it is important to ensure that precise quantities of reagents are dispensed in each assay, and/or to ensure the coefficient of variation (CV) within the wells of an assay plate is less than approximately 5%. The quantitative indication of the amount of a constituent present may be indicated by various readouts, for example, light emission intensity or color change. A precise, consistent and reliable mechanism for dispensing a predetermined amount of reagent, used as a baseline or control model, is important for obtaining accurate test results. Furthermore, many chemical entities have subtle variations in their chemical structures. Initially, chemical variations may appear to be rather insignificant. For example, the difference between one protein and another might be the addition or deletion of a single amino acid. Under “normal” biological conditions the addition or deletion of a single amino acid in a particular protein may be insignificant, but under aberrant or stressed biological environments, present in a diseased condition, the two proteins may act very differently. Therefore, it is often necessary to perform hundreds or even thousands of discrete miniaturized test assays in order to collect enough data to determine the subtle characteristic differences between the entities being tested.

The Aurora Biosciences Corporation NanoWell® Assay Plate is a multi-well microplate which may be used as a test plate. The small well size of the Aurora NanoWell® Assay Plate, approximately 2 microliters in volume, allows for 3,456 individual wells to fit in a microplate having the same size footprint as that of a standard 96-well microplate. The assay volume of a 3,456-well microplate is approximately 100 times smaller than most conventional screening assays. This reduces the cost per test by reducing the amount of expensive reagents and compounds consumed in each assay and conserves compound libraries that often consist of only very small amounts of each test compound. The microplates are used for various applications including assay preparation, fluorescence detection, and data analysis. Common formats of microplates include 96-well plates, 384-well plates, and 1,536-wellplates.

Various automated methods are known for dispensing reagents into multi-well assay plates. One such method uses a bank of valves linearly arranged to dispense into each of the wells in an entire row or column of a microplate. For example, a dispenser may have 48 valves that can dispense into each well of an entire row of a 3,456 well microplate (See FIG. 1B). To fill each of the wells of a 3,456-well microplate, such a dispenser would complete seventy-two stop and go movements to fill the 72 columns of the microplate. Such a dispenser can fill an entire 3,456-well microplate in approximately 30 seconds. In the case where the dispenser dispenses a single reagent through the 48 discrete valves, typically a fluid manifold is utilized. This design has at least three drawbacks: 1) the use of 48 valves per reagent results in substantial variations in the reagent volume dispensed from each of the 48 tips due to subtle differences in the manufacturing of each valve dispenser; 2) the use of a fluid manifold results in a dead volume of reagent on the order of several milliliters, resulting in the waste of reagents; and 3) each individual reagent to be added requires its own bank of 48 valves resulting in a very complex mechanical and electrical system, increased equipment breakdown, and poor production efficiency.

Alternatively, a single valve dispenser may be used to fill all 3,456 wells of a 3,456-well microplate. This would minimize some of the problems associated with a single reagent being dispensed from a large number of valves, including valve-to-valve variations, high dead volume space, and system complexity. However, 3,456 stop and go movements would be needed to fill the entire microplate, resulting in a significant increase in dispensing time. For example, in a typical dispenser it takes approximately half a second (500 milliseconds) to move from one well to the next, and approximately 20 milliseconds to dispense the reagent. Therefore, the overall time needed to fill all 3,456 microplate wells is about 30 minutes. Most of the 500 milliseconds are taken up by the acceleration and deceleration needed to move from one well and to stop at the next well. Thus, what the single dispenser gains in dispensing reliability, it lacks in speed and efficiency.

Dispensing on-the-fly is an alternative to the “stop and go” dispensing method. On-the-fly reagent dispensing requires either the microplate or the reagent dispensing device to move substantially continuously while the other of the reagent dispensing device or the microplate remains stationary. On-the-fly dispensing addresses to some degree the speed of dispensing. However, the 48-tip design still suffers from the same aforementioned problems even if using on-the-fly dispensing. On-the-fly dispensing with the single-tip design decreases overall dispensing time to a certain degree. However, such known on-the-fly dispensing techniques do not utilize a geometric arrangement of dispensing tips and associated mechanical structures to further optimize speed of dispensing while still reducing dead volume and mechanical complexity.

Dispensing reagents into high-density plates such as a 3,456-well microplate presents a special challenge. Reagents in the microliter or nanoliter range must be dispensed quickly and with enough precision to achieve a coefficient of variation (CV) of less than 5% across the entire plate. Moreover, since volumes of reagents typically are in the range of a few microliters, a total dead volume of more than a few hundred microliters results in a relatively significant amount of reagent waste.

Additionally, known dispensing apparatuses typically require replacement of dispensing components between uses. For example, the reagent containers, fluid lines, and other associated accessories must be switched out for each use. Doing so complicates use of the dispensing apparatus.

Accordingly, there is a need for a method and apparatus capable of automated on-the-fly dispensing of reagents, and replacement of reagent dispensing hardware and accessories, that is more efficient than known methods and apparatuses.

### SUMMARY OF THE INVENTION

The present invention includes a method and apparatus capable of automated on-the-fly dispensing of reagents, and replacement of reagent dispensing hardware and accessories, that is accurate, reliable, and more efficient than known methods and apparatuses.

The apparatus of the present invention includes a detachable reagent dispensing module supported by a support frame. The dispensing module includes a self-contained pressurized fluid delivery subsystem, including pressurized reagent containers, and associated accessories arranged such that each reagent container is connected via a corresponding discrete fluid path to a corresponding discrete reagent dispensing tip. The fluid paths are relatively short to minimize dead volume (i.e., reagent contained in a fluid path between the container and the dispensing orifice which generally gets wasted when changing assays, reagents, dispensers or fluid lines) during system operation. The dispensing tips are supported by a common dispensing head, and are arranged geometrically such that the center of each of the dispensing tips are separated by distances corresponding to relevant dimensions of particular assay plates to be used therewith. Such a geometric arrangement allows for dispensing of multiple reagents into multiple corresponding target wells of an assay plate, efficiently and precisely.

The self-contained pressurized fluid delivery subsystem allows for the dispensing module to be attached to, or detached from, the support frame without cumbersome manipulation of reagent containers or associated fluid delivery hardware. Connectors such as bolt(s), pressure clamp(s), and/or quick-release connector(s), are provided to enable attachment and detachment of the dispensing module. The detachability of the dispensing module facilitates reagent substitution if additional reagents are needed for continued testing purposes, or module replacement should fluid tubes, electrical connections, or other associated accessories require maintenance or repair. Moreover, detachability of the dispensing module greatly facilitates sharing of the equipment among many users without fear of cross-contamination between reagents.

During on-the-fly dispensing of reagents, as described herein, the dispensing tips and/or the assay plate may be in motion. In one embodiment of the present invention, the dispensing tips remain stationary while a motorized drive system or arrangement of stages moves the assay plate in a substantially continuous switchback pattern beneath the dispensing tips, during which time reagents are dispensed through the dispensing tips into target wells of the assay plate in accordance with a timing algorithm synchronized to the switchback pattern and dependent on the assay plate and dispensing tip geometry. The dispensing tips are arranged geometrically such that distances corresponding to relevant dimensions of particular assay plates to be used therewith separate the centers of the dispensing tips.

In one embodiment of the present invention, after initial positioning, the motor drive system moves the microplate approximately 1.5 millimeters, approximating the well-to-well center spacing of a Nanowell® 3,456-well microplate, and a computer-program-controlled electronic trigger is provided to dispense reagent at appropriate time intervals such that desired amounts of reagents are dispensed into corresponding target wells of the microplate. The time intervals are less than the time required for the dispensing tips to move past the target wells. As the microplate moves in a substantially continuous switchback pattern (as further described herein) the triggers continue accordingly such that the target wells are filled with the desired amounts of the reagents.

Each reagent is dispensed from a corresponding pressurized reagent container through a corresponding discrete fluid path. Each fluid path includes a fluid delivery line, a dispensing device for selectively dispensing the reagent, and a fluid tube. The fluid tubes terminate at corresponding dispensing tips where the reagents are dispensed into target wells, as described herein. The geometric arrangement of the dispensing tips as described herein allows for multiple reagent dispensing, while avoiding the pitfalls associated with known devices, e.g., increased coefficient of variation (CV) within each column of the microplate, substantial dead volume, and a high level of system complexity.

In particular, an array of dispensing tips produces accurate results in a timely manner. As used herein, an array refers to an array having at least 2 or more dispensing tips and not necessarily the same number of rows as columns. For simplicity, a rectangular array is 2×2 disclosed, which allows for dispensing of 2 or more reagents substantially simultaneously into 4 corresponding microplate wells in a highly efficient manner. Thus, the 2×2 arrangement generally produces results 4 times as fast as the single-tip design, yet is compact enough that the dispensing tips do not collide with the raised perimeter wall (also referred to as a “raised skirt”) of industry-standard microplates when dispensing reagents in a switchback pattern as described herein. The compact rectangular dispensing tip design is an especially significant feature for avoiding the raised skirt when using on-the-fly dispensing, as described herein, which requires dispensing tips to occupy the border area, the area between the outer microplate wells at the perimeter of the well field and the microplate's perimeter walls. Thus, when using an on-the-fly dispensing technique, the 2×2 geometric arrangement of dispensing tips, and mechanical structures associated therein, including discrete fluid paths, together optimize speed of dispensing while reducing dead volume and system complexity and maintaining an acceptable coefficient of variation (CV).

Accordingly, the present invention as described herein provides a method and apparatus capable of automated on-the-fly dispensing of reagents, and replacement of reagent dispensing hardware and accessories, that is more efficient than known methods and apparatuses. Further objects and advantages of the present invention will be apparent in the detailed description which follows, read in conjunction with the drawings.

### BRIEF DESCRIPTION OF THE DRAWINGS

In the following detailed description of the invention reference is made to the accompanying drawings which form a part hereof, and in which are shown, by way of illustration, specific embodiments in which the invention may be practiced. These embodiments are described in sufficient detail to enable those skilled in the art to practice the invention. Other embodiments may be utilized, and structural, logical, and electrical changes may be made, without departing from the scope of the present invention.

FIG. 1A shows a known reagent dispenser.

FIG. 1B shows another known reagent dispenser.

FIG. 2 is a perspective view of an industry-standard microplate.

FIG. 3 is a perspective view of a one embodiment of a dispensing apparatus in accordance with the present invention, including the frame and the detachable dispensing module.

FIG. 4 is a perspective view of the detachable dispensing module shown in FIG. 3.

FIG. 5A is a perspective view of the dispensing head shown in FIG. 3.

FIG. 5B is a cross-sectional view of the dispensing head of FIG. 5A, along line 5B-5B.

FIG. 6 (consisting of diagrams 6A-6C) is a timing chart illustrating a typical spatial triggering scheme used in accordance with a preferred embodiment of the present invention.

FIG. 7 is a block diagram illustrating the hardware components used in conjunction with the apparatus of the present invention to carry out a preferred method of the present invention.

FIG. 8 (consisting of diagrams A through J) illustrates a typical reagent dispensing pattern in accordance with the present invention.

FIG. 9 is a flow chart illustrating a method embodiment of the present invention.

FIGS. 10 and 11 are graphs of experimental data illustrating the dispensing accuracy accomplished using an embodiment of the present invention.

### DETAILED DESCRIPTION OF THE INVENTION

Embodiments of the invention will now be described with reference to the accompanying figures, wherein like reference numerals refer to like elements throughout. Unless otherwise expressly stated herein, the terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Reference throughout this specification to “one embodiment”, “an embodiment” or “preferred embodiment” means that a particular feature, structure, or characteristic described in connection with the embodiment is included in at least one embodiment of the present invention. Thus, the appearance of the phrases “in one embodiment”, “in an embodiment” or “a preferred embodiment” in various places throughout this specification are not necessarily all referring to the same embodiment. Furthermore, the particular features, structures, or characteristics may be combined in any suitable manner in one or more embodiments.

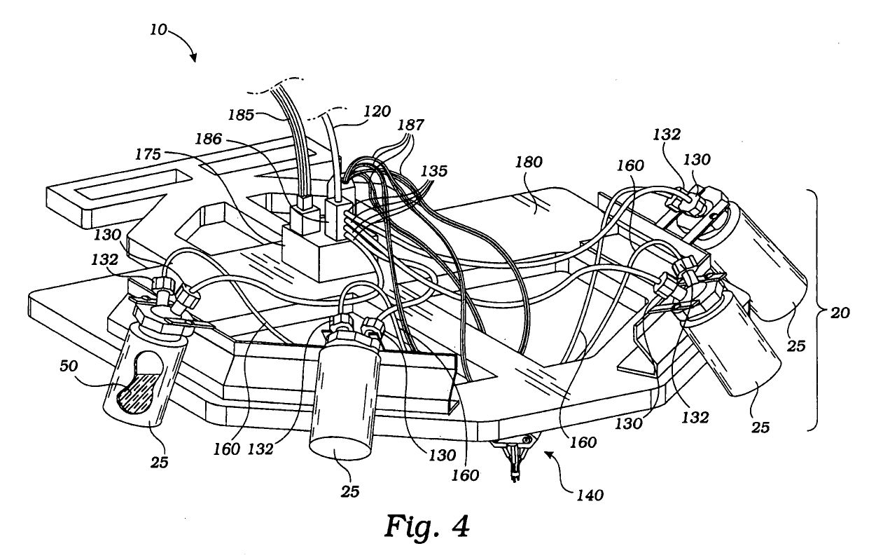

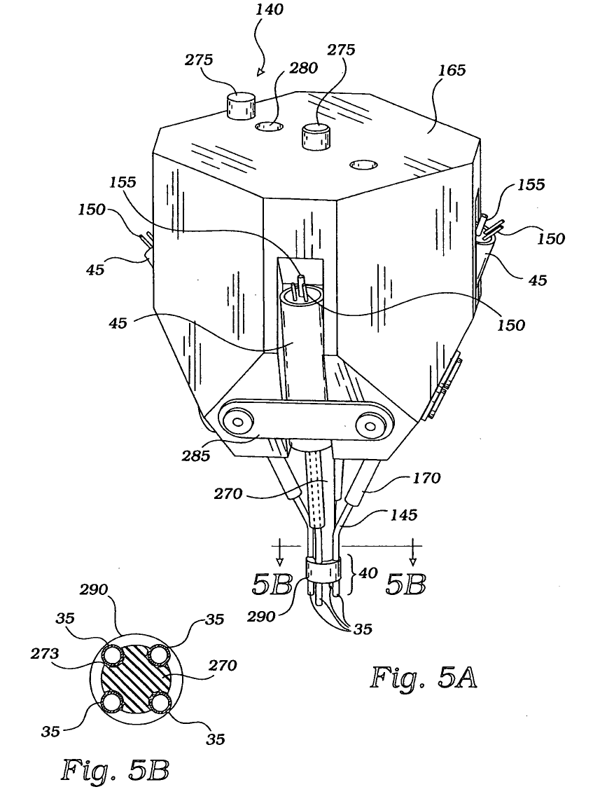

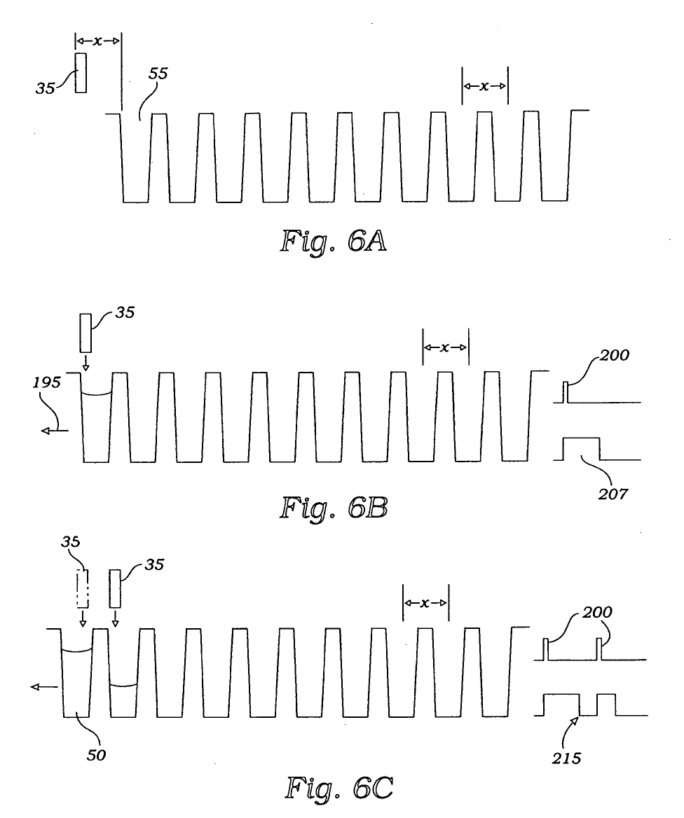

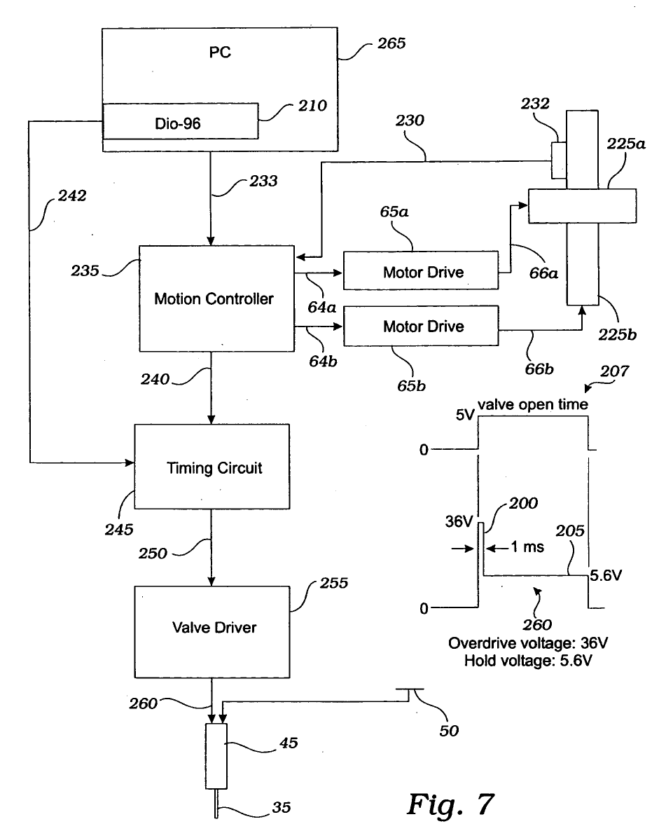

The apparatus of the present invention, as described herein and shown in FIGS. 3 and 4, is capable of automated on-the-fly dispensing of reagents, and replacement of reagent dispensing hardware and accessories, in an accurate, efficient, faster, and more reliable manner than known methods and apparatuses. The apparatus 5 includes a detachable reagent dispensing module 10 supported by a support frame 15. The detachable reagent dispensing module 10 includes a self-contained pressurized fluid delivery subsystem 20 as further described herein, including a plurality of pressurized reagent containers 25, and associated accessories arranged such that each reagent container 25 is fluidly connected to a corresponding discrete fluid path which begins with a corresponding fluid delivery line 160 and terminates in a corresponding discrete dispensing tip 35. The dispensing tips 35 are collectively arranged in an array 40, one embodiment shown in FIGS. 5A and 5B. Each fluid path has a corresponding dispensing device 45 for controlling selective dispensing of a corresponding reagent 50 through a corresponding dispensing tip 35 in response to a corresponding electrical actuation signal. The fluid delivery subsystem 20 is referred to as pressurized herein, even though typically the subsystem 20 is pressurized only during operation of the apparatus 5, as described herein.

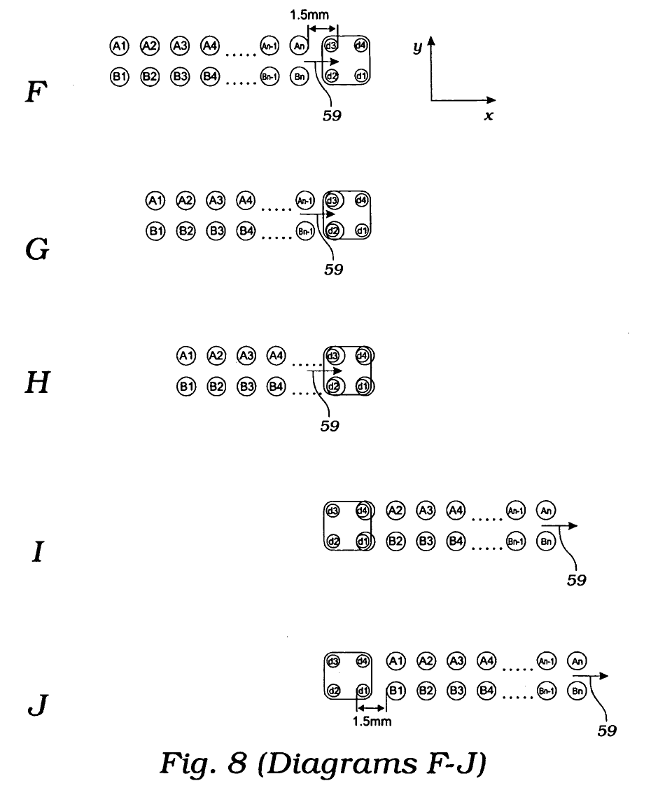

The apparatus 5 of the present invention is used to populate target wells 55 of a microplate 60 (also commonly referred to as a plate, a well plate, an/or a microplate depending on the context) with reagents 50 using a switchback pattern as further described herein. The switchback pattern is achieved by a motor drive system 65 controlled with computer software based on a timing algorithm dependent upon the geometric characteristics/dimensions of the assay plate 60, the volumes of reagents to be dispensed, and the geometry/dimensions of the dispensing tip array 40, all as further described herein. Motor drive system 65 may be a single drive, but preferably two drives are used—one each to control horizontal and vertical movement of the microplate 60 within a plane (see FIG. 7). The term “software” as used herein includes software, firmware, and a combination of software and firmware.

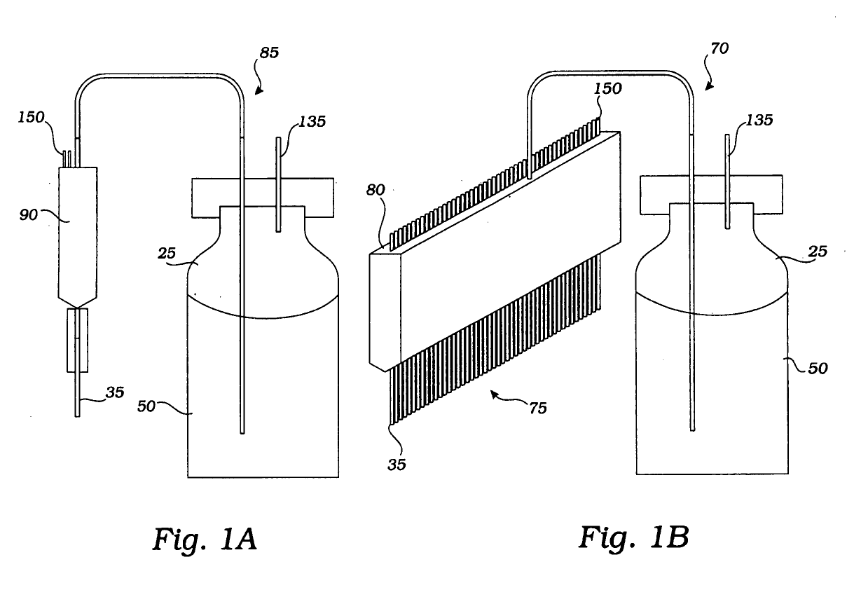

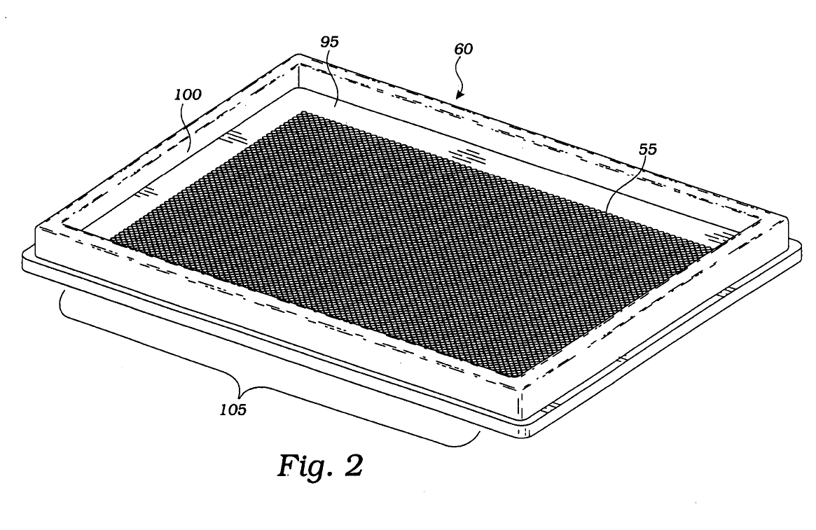

Referring now to FIGS. 1A and 1B, several known reagent dispensers are shown. FIG. 1B shows a previously known reagent dispenser 70 that uses a bank of 48 valves 75 to dispense a single reagent simultaneously into one column of the 72 columns of a 3,456-well microplate. Seventy-two stop and go movements are needed to fill the 72 columns of the microplate. It would thus require approximately 30 seconds to fill the entire microplate. Since this method requires that a single reagent flow through 48 discrete valves, typically a fluid manifold 80 is required. Thus, this design has at least three drawbacks: 1) the use of 48 valves for a single reagent results in substantial variation in the reagent volume within each column of the microplate due to subtle differences in the manufacturing of each valve dispenser; 2) the use of a fluid manifold results in a dead volume of reagent on the order of several milliliters, resulting in the waste of reagent, chemical, or other vital fluid; and 3) each reagent requires a bank of 48 valves resulting in a very complex mechanical and electrical system, increased equipment breakdown, and poor production efficiency.

Alternatively, another known reagent dispenser 85, as shown in FIG. 1A, uses a single valve dispenser 90 to fill all 3,456 wells of a 3,456-well microplate. This would minimize some of the problems associated with a single reagent being dispensed from a large number of valves, including valve-to-valve variations, dead volume space, and system complexity. However, 3,456 stop and go movements would be needed to fill the entire microplate, resulting in a significant increase in dispensing time. For example, it takes approximately half a second (500 milliseconds) to move from one well to the next, and approximately 20 milliseconds to dispense the reagent. Thus, the overall time needed to fill all 3,456 microplate wells is about 30 minutes. Most of the 500 milliseconds are taken up by the acceleration and deceleration needed to move from one well and to stop at the next well. Therefore, while the single dispenser improves dispensing precision and reliability, it lacks speed and efficiency.

Turning to FIG. 5A, the present invention utilizes a multi-tip dispensing array 40 with discrete corresponding fluid paths associated with each corresponding dispensing tip 35, to minimize the problems associated with a single tip design or a 48-tip design as described herein. Further as described herein, the geometric configuration of the multi-tip array 40 of the present invention is designed to maximize the speed and efficiency of dispensing reagents into an assay plate on-the-fly while maintaining a high degree of precision, taking into consideration industry-standard microplate designs.

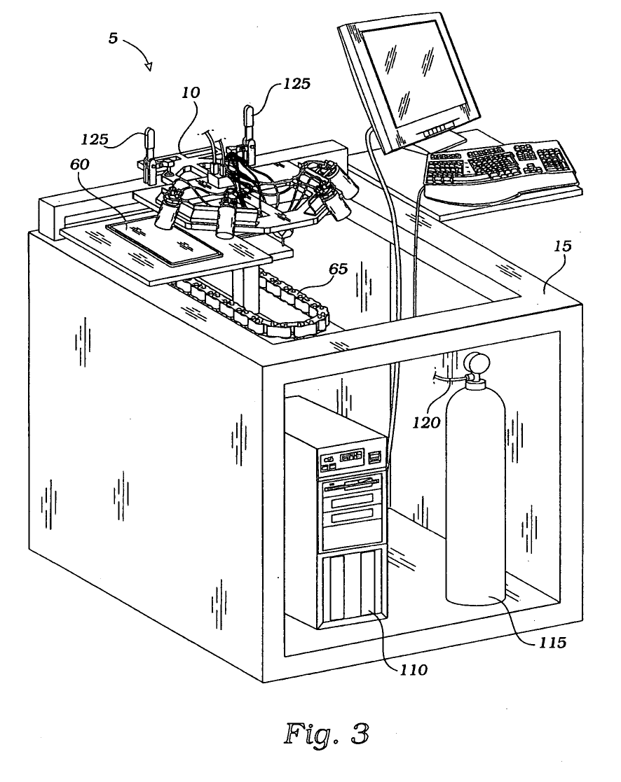

Referring now to FIG. 2, a perspective view of an Aurora Biosciences NanoWell® Microplate 60 which has an industry-standard microplate footprint is shown. A narrow border area 95 around the perimeter of microplate 60 is void of any wells. A raised skirt 100 surrounds a well matrix 105 comprising a field of individual wells 55. The raised skirt 100 provides a surface for receiving a plate cover (not shown). As described herein, the raised skirt 100 poses a potential risk of damage to the delicate dispensing tips 35 if a tip contacts the raised skirt 100 during operation. Such a risk might be avoided by positioning the microplate 60 at a depth relative to the tip array 40 such that the top surface of the skirt 100 is well below the height of the ends of the tips 35 during the dispensing operation. However, doing so complicates the dispensing operation in several important ways. For example, such a configuration increases the risk that dispensed reagents will miss the target wells 55 due to the longer distance the reagents have to travel from the dispensing tips 35 to the target wells 55. The timing for dispensing will likewise be much more complicated. Thus, it is desirable to have the dispensing tips 35 as close as possible to the surface of the plate 60 during dispensing to minimize such risks. Accordingly, the geometric arrangement of the multi-tip dispensing array 40 of the present invention is designed to allow close placement of the tips 35 to the top surface of the wells 55, while also avoiding contact with the skirt 100 during operation maintaining the ability to align each tip 35 with each well 55.

It will apparent to those of skill in the art that the raised skirt 100 can be eliminated in certain micoplate designs. The absence of a raised skirt 100 allows for a larger rectangular arrangement of tips, since collision with the skirt 100 is no longer a limiting factor. Moreover, the larger the array of microtips, the faster the reagent addition can occur for any given microplate.

As used herein, a rectangular array refers to an array having at least 2 or more dispensing tips. In some embodiments, the arrays may have the same number of rows and columns, such as 3×3, 4×4, 5×5, 6×6, and so on. In other embodiments, the array may have different number of rows and columns, such as 1×2, 2×1, 1×3, 3×1, 1×4, 4×1, 1×5, 5×1, 1×6, 6×1, and so on. In other embodiments, the microtip array may be N×1, N×2, N×3 and so on, or 1×N, 2×N, 3×N and so on, where N≧2. In still other embodiments, the microtip array may also have other geometric shapes besides rectangle, such as a triangle, hexagonal, parallelogram, etc., that correspond to any configuration of the wells on a microplate.

Turning now to FIG. 3, a perspective view of one embodiment of a dispensing apparatus 5 in accordance with the present invention is shown. The dispensing apparatus 5 includes a support frame 15 and a detachable reagent dispensing module 10. The support frame 15 provides a stable base support for the dispensing module 10 and associated accessories. Furthermore, the support frame 15 may be adapted to house other associated equipment, such as: a motor drive system 65 which moves the microplate 60; a computer 110 having software programmed to control motor drive system 65 which in turn generates encoder counts used to control dispensing devices 45; a pressurized air source 115 to pressurize the fluid delivery subsystem 20; and any required electrical connections and power supply sources.

The dispensing module 10 (shown in more detail in FIG. 4) is removably attached to the support frame 15. The dispensing module 10 comprises a self-contained pressurized fluid delivery subsystem 20. The dispensing module 10 is adapted for complete and reproducible attachment to or detachment from the support frame 15, thus avoiding cumbersome manipulation of reagent containers 25 and/or fluid paths between uses. For example, the processing of liquid samples, such as in biochemical and pharmaceutical research, typically demands complicated liquid processing which can involve throughput rates of over 100,000 samples per day. The processing of liquid samples may require that a reagent or reagent combinations be used to satisfy testing protocols. Furthermore, replacement of reagent hardware may be necessary to avoid contamination of liquid samples from previous reagents that remain in the fluid paths, or the unnecessary mixing of reagents that could result in inappropriate reagent ratios leading to inaccurate results.

The detachable dispensing module 10 of the present invention avoids these problems by enabling replenishment or replacement of reagents 50 for continued or subsequent testing, without requiring the cumbersome and inefficient disconnecting and reconnecting, or flushing, of fluid paths, reagent containers 25, and other associated equipment. Instead, the entire self-contained pressurized fluid delivery subsystem 20 may be easily and efficiently replaced, and only the single air supply line 120, along with any necessary electrical connections, must be reconnected upon replacement of the dispensing module 10.

One such structure for enabling the simple and reproducible attachment and detachment of the dispensing module 10 is a set of quick-release clamps 125 which are designed to securely attach the dispensing module 10 to the support frame 15. Locking latches, tabs, pins, heavy magnets, combinations of the aforementioned, or other suitable means may be used as well. The quick-release clamps 125 or other suitable attachment and detachment means may be located on a platform 180 of dispensing module 10, or even on the support frame 15 of apparatus 5. The platform 180 is convenient for holding, placing or securing the pressurized fluid delivery subsystem 20 and all other mechanical and electrical fixtures associated with the detachable dispensing module 10, once the module 10 has been removed from the dispensing apparatus 5.

The fluid delivery subsystem 20 includes reagent containers 25 and associated accessories arranged such that each reagent container 25 is fluidly connected to a corresponding discrete fluid path which begins with a corresponding fluid delivery line 160, and terminates in a corresponding discrete dispensing tip 35. The dispensing tips 35 are collectively arranged in a rectangular array 40, and are disposed on a dispensing head 140 which is mounted to the platform 180. Typically, reagent containers 25 are made from plastic, glass, or other suitable material used for containing a liquid, and may be secured to the dispensing module via clamps, latches, straps, hardware such as bolts, or other suitable means. Each fluid path has a corresponding dispensing device 45 for controlling selective dispensing of a corresponding reagent 50 through the corresponding dispensing tip 35 in response to a corresponding actuation signal.

Each reagent container 25 further comprises a corresponding fluid port 132 and a corresponding air port 130. The fluid ports 132 connect the fluid delivery lines 160 to the reagent containers 25. The air ports 130 connect the air delivery lines 135 to the reagent containers 25. The reagent containers 25 receive a substantially constant source of pressurized air 115 via corresponding air delivery lines 135 and air ports 130, such that the reagents 50 contained in the reagent containers 25 are subjected to substantially constant pressure during operation of the dispensing apparatus 5. The pressure can be any suitable pressure, one embodiment being approximately eight pounds per square inch (PSI). The pressure causes the reagents to be dispensed upon opening of the corresponding dispensing devices 45 which are controlled by computer software programmed based on a timing algorithm which takes into consideration the dimensions and geometry of the microplate 60 and the multi-tip dispensing array 40 being used, and the switchback pattern being used, as further described herein.

A single fluid path is the path extending from reagent container 25 to dispensing tip 35. The path includes a fluid delivery line 160 leading from the reagent container 25 to a fluid tube 145. The fluid delivery line 160 is preferably flexible material, and the fluid tube 145 is preferably metal. The fluid tube 145 has an adaptor 155 for receiving the fluid delivery line 160, and extends therefrom to the dispensing tip 35 which is also part of the tube 145. A portion of the tube 145 is enclosed within dispensing device 45, described in more detail herein.

The fluid paths are relatively short to minimize the dead volume of the dispensing module 10. For example, the entire length of a fluid path from a reagent container 25 to a corresponding dispensing tip 35 is preferably less than approximately 25 centimeters (cm). In addition or alternatively, the entire volume of a fluid path from a reagent container 25 to a corresponding dispensing tip 35 is preferably less than approximately 200 microliters. In known systems, the use of a fluid manifold results in dead volume on the order of tens of milliliters, resulting in the waste of reagent, chemical, or other vital fluid. The use of discrete fluid paths in the present invention eliminates the need for a fluid manifold. In a preferred embodiment of the present invention, reagents 50 are dispensed from corresponding dispensing tips 35 approximately 14 millimeters long, having an inner diameter of approximately 0.20 millimeters, which provides for a smooth laminar flow. By using fluid paths that are less than approximately 25 cm, dead volume is significantly reduced to approximately 200 microliters or less, thus conserving reagent 50. Additional dispensing module accessories may include a routing block 175 for the convenient and systematic routing of each of the discrete fluid delivery lines 160, wire connection 185 which operably connects to a computer 110, and electrical wiring 187 operably connected to each of the dispensing devices 45 for carrying electrical signals. Furthermore, routing block 175 may contain an air manifold 186 for receiving air supply line 120 which receives air from a source of pressurized air 115 that is supplied to a plurality of air delivery lines 135 extending from the air manifold 186, each air delivery line 135 being connected to a corresponding one of the plurality of reagent containers 25. In this manner, the fluid delivery subsystem 20 is pressurized during operation of the apparatus 5, as pressurized air may be supplied into each of the reagent containers 25 via corresponding air delivery lines 135 substantially continuously during dispensing of reagents 50.

Turning now to FIGS. 5A and 5B, the dispensing head 140 is shown in detail. Dispensing head 140 contains the terminal portions of the fluid paths, and is attached to the platform 180 of the dispensing module 10 by use of bolts, screws, or other suitable means. For example, boreholes 280 may be adapted to receive bolts from the underside of dispensing head 140. Proper alignment of dispensing head 140 may be accomplished by utilizing alignment pins 275 designed to mate with corresponding indents or holes (not shown) on platform 180. Alternatively, dispensing head 140 and dispensing module 10 may be formed as an integrated component.

Dispensing head 140 includes a support block 165 that provides a platform for supporting discrete fluid tubes 145, which are further secured to support block 165 by brackets 285. Each discrete fluid tube 145 is fluidly connected to a corresponding discrete dispensing device 45 for controlling selective dispensing of a corresponding reagent 50 through a corresponding dispensing tip 35. Typically, each dispensing device 45 includes corresponding electrical lead(s) 150 for receiving signals that control the opening and closing of a valve contained therein, an adaptor 155 for receiving a corresponding fluid delivery line 160, and a corresponding section of fluid tube 145. Tip array 40 may be further guided and supported for precision accuracy by a ring 290 used to clamp tip array 40 to a support rod 270. Support rod 270 has grooves 273 for receiving tip array 40. Ring 290 may be soldered, brazed, laser welded or glued around tip array 40.

Acting as a supporting platform, the support block 165 may be constructed of any suitable material capable of providing stability to the dispensing devices 45, rectangular tip array 40, and associated hardware for securely receiving the aforementioned. Additional stability and protection of the fluid tubes 145, from bending or other inappropriate contact, may be achieved by using protective sleeves 170. Ideally, the protective sleeves 170 are associated with a section of the fluid tubes 145 located between the dispensing devices 45 and the dispensing tips 35. Protective sleeves 170 may be PVC tubing, rubber, Tygon®, or other suitable material.

Discrete adaptors 155 fluidly connect corresponding fluid delivery lines 160 to corresponding dispensing devices 45. The dispensing devices 45 may be solenoid valves or piezoelectric dispensers, for example. The dispensing devices 45 selectively control reagent dispensing. Solenoid valve dispensers, of the type used in one embodiment of the present invention, are commonly used for ink-jet printing and are commercially available from sources such as The Lee Company located in Westbrook, Conn. Electrical and mechanical operation of a solenoid valve dispenser is well known in the art. Briefly, the dispenser generally comprises a solenoid portion, a valve portion, and electrical leads 150. The solenoid portion comprises an electromagnetic coil, a static core, and a movable plunger. The static core and movable plunger are disposed within a hollow cylindrical sleeve (fluid tube 145) to allow passage of a reagent. The static core and movable plunger are preferably formed of a ferrous or magnetic material. When the solenoid coil is energized through electrical leads 150, as described herein, via electrical signals controlled by a computer program, a magnetic field is created which draws the plunger toward the static core and away from a valve portion allowing pressurized reagent to be dispensed past the valve opening. Reagent then exits the solenoid valve openings into a section of the fluid tube 145 that terminates at a dispensing tip 35 where reagent 50 is dispensed into target wells 55.

Standard assay plates 60 can be described in dimensions relating to the well-to-well spacing between the centers of target wells 55. Well-to-well spacing of various well plates include: approximately 1.50 millimeters for a 3,456-well microplate; 2.25 millimeters for a 1536-well plate; and 4.50 millimeters for a 384-well plate. The dispensing tips 35 are housed in a common dispensing head 140, and are arranged in a geometric arrangement in which the distances between centers of the dispensing tips 35 are calculated to correspond to a timing algorithm associated with such a microplate 60 having known dimensions. Such a geometric arrangement, in conjunction with a computer program to control the opening and closing of the dispensing devices 45, allows for dispensing of multiple reagents 50 substantially simultaneously into multiple corresponding target wells 55 of a microplate 60, efficiently and precisely.

In one particular embodiment, a rectangular, or more specifically, a 2×2 geometric arrangement, permits the dispensing tips 35 to easily be adapted for efficient and precise reagent dispensing into wells 55 on plates 60 of various dimensions. For example, dispensing tips 35 having a distance of approximately 1.50 millimeters between the centers of the dispensing tips 35 in a single row may be used to dispense into a 3,456-well microplate in which the center-to-center distance between wells 55 in a row or column is 1.50 millimeters. Dispensing tips 35 having a distance of approximately 2.25 millimeters between the centers of the dispensing tips 35 in a single row may be used to dispense into a 1536-well plate in which the center-to-center distance between wells 55 in a row or column is 2.25 millimeters. Dispensing tips 35 having a distance of approximately 4.50 millimeters between the centers of the dispensing tips 35 in a single row may be used to dispense into a 384-well plate in which the center-to-center distance between wells 55 in a row or column is 4.50 millimeters. The dispensing tips 35 may similarly be arranged to dispense into other size assay plates 60.

In the embodiment shown, the 2×2 array 40 (see FIGS. 5A and 5B) has an advantage over a 4-tip linear array because typical microplates may have a raised skirt 100 that surrounds the well matrix 105. The 2×2 array 40 is compact, thus it does not collide with the raised skirt 100 when aligning with target wells 55 that are on the perimeter of the well field. Similarly, the 2×2 array 40 is preferred over known arrangements because the 2×2 array 40, used to dispense reagent in a switchback pattern, allows for dispensing of up to 4 different reagents substantially simultaneously into 4 corresponding target wells 55 of a microplate. Three or more tips in a linear arrangement, as described herein, might collide with the raised skirt 100 near the microplate perimeter.

The use of microplates which lack a raised skirt 100 alleviates the problem of collision with the microtips and allows for a larger array of microtips. This, in turn, decreases the time required for dispensing all of the required reagents into the microplate. Such larger arrays of microtips are especially useful for assays and methods that require the dispensation of more than four different reagents. One such use would be for PCR, which requires the addition of at least four separate phosphonucleotides, ATP and a ligase.

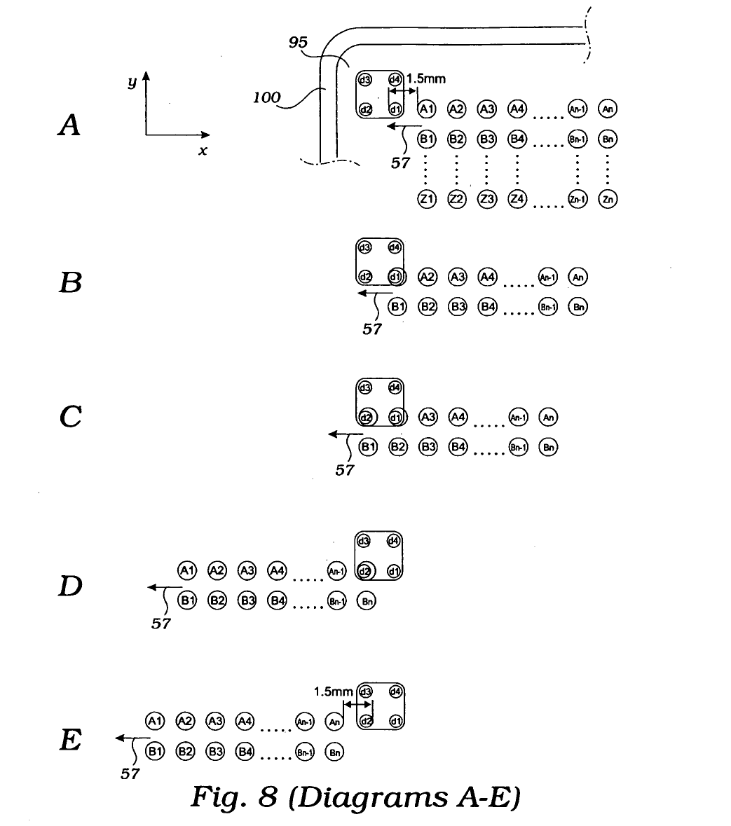

Turning now to FIG. 6, a timing chart illustrating a typical spatial triggering scheme for on-the-fly dispensing in accordance with a preferred embodiment of the present invention is shown. For illustration, a spatial triggering scheme for a 2×2 array of dispensing tips 35 having a distance of approximately 1.50 millimeters between the centers of the dispensing tips 35 in a single row, used to dispense into a 3,456-well microplate, will be discussed. A single tip 35 is shown for convenience. In this example illustrated in FIGS. 6A-6C, the distance “x” is 1.50 millimeters. The dispensing tip 35 remains stationary while microplate 60 moves beneath in the X-Y plane. FIGS. 6A, 6B, and 6C represent sequential points in time respectively.

FIG. 6C shows two wells 55 having different amounts of reagent 50, corresponding to the open intervals seen in waveform 215 which are of different lengths of time. This illustrates that the amount of a particular reagent 50 to be dispensed into a particular well 55 may be controlled at least partially by controlling the length of the open interval during which the particular reagent 50 is dispensed into the particular well 55. It will be readily apparent to those skilled in the art that the spatial triggering scheme and overall dispensing algorithm may be adjusted to accommodate other assay plates, tip arrays, and dispensing of desired volumes of reagents.

Movement of microplate 60 is substantially continuous (on-the-fly) and is accomplished by a motor drive system 65. Microplate 60 is initially positioned as seen in FIG. 6A, with the left edge of tip 35 at a distance of x from the left edge of the first target well 55. After initial positioning, motor drive system 65 commences movement of microplate 60 in the X-direction. When the microplate has moved approximately a distance x (approximating the well-to-well center spacing of microplate 60) as shown by arrow 195, the position of the target well 55 is as shown in FIG. 6B. Once tip 35 is aligned with its first target well 55 (left edge of tip 35 is at or within left edge of target well 55), dispensation into the well 55 is triggered. The trigger is a computer-program-controlled electronic trigger 240 (see FIG. 7) which is conducted through electrical leads 150 of dispensing device 45, to actuate and de-actuate dispensing valves for appropriate open time intervals as depicted by waveform 207 (see FIG. 6B and FIG. 7), such that the desired amount of reagent 50 is dispensed into the target well(s) 55. The microplate 60 continues to move in the x-direction as reagent is dispensed from the tip 35 into the well 55.

An initial overdrive voltage 200 is provided to open dispensing devices 45, followed by a holding voltage 205 (see FIG. 7). Once the trigger is cut-off, the trigger-induced magnetic field(s) end(s), and the dispensing devices close preventing further reagent 50 from being dispensed. Overdrive voltage 200 and holding voltage 205 both occur during open time interval 207, as seen by waveform diagram 260 in FIG. 7. The open time interval 207 is less than the time required for the dispensing tip to “fly” above its target well, as shown by waveform diagram 215 associated with FIG. 6C. That is, the dispensing stops prior to the right edge of tip 35 reaching the right edge of well 55 as seen by the dotted representation of tip 35 in FIG. 6C. Thus, dispensing into well 55 ends by the time well 55 has moved out from under tip 35.

In the preferred embodiment as described herein, the time interval in which a tip 35 is over a well 55 is less than approximately 20 milliseconds. This is based on the speed of microplate 60, as well as the relative dimensions of the tip opening and the inner diameter of the well. For example, the inner diameter of a tip opening in a preferred embodiment of the 2×2 array used in conjunction with a 3,456-well microplate is approximately 0.2 millimeters, and the inner diameter of a well is approximately 1 millimeter. During the 20 milliseconds, when dispensing tip 35 is above its target well 55, dispensing tip 35 is referred to herein as being aligned with the well 55. Accordingly, such alignment refers not to a single position, but to a set of continuous positions during which the complete opening of the dispensing tip 35 “passes over” well 55 from one edge of well 55 to the other, thus maximizing the alignment time of tip 35 over well 55. As microplate 60 moves in a substantially continuous switchback pattern (as further described herein), the triggers 240 continue accordingly such that the wells are filled with the desired amounts of reagents 50. In this example, a dispensing cycle would occur each time plate 60 moved 1.5 millimeters, so long as at least one tip 35 was aligned with its target well 55 at that time.

Referring now to FIG. 7, a block diagram illustrating the hardware components used in accordance with the apparatus of the present invention to carry out the method of the present invention is shown. The method is preferably controlled by computer software. In one embodiment in which dispensing apparatus 5 is used to dispense into a 3,456-well microplate, motor drive system 65 includes two motor drives 65a and 65b for driving motorized stages 225a and 225b respectively via connections 66a and 66b respectively. Motor drives 65a and 65b are controlled by motion controller 235 as seen by control signals 64a and 64b respectively. Motorized stages 225a and 225b in turn move microplate 60. As motorized stage 225b moves along its axis, encoder counts 230 are sent from linear encoder 232 to a motion controller 235 which is programmed to generate a master trigger 240 every time the stage moves 1.5 millimeters. The master trigger(s) 240 are sent to a timing circuit 245 that has two components: 1) a First-In-First-Out (FIFO) memory element pre-programmed with 3,456 valve open times, and 2) logic circuitry triggered by master triggers 240 from motion controller 235 to send open times from the FIFO to valve driver 255. Timing circuit 245 communicates with PC 265 via a standard 100-pin SCSI cable 242. The open times are transistor-transistor logic (TTL) pulses 250 of varying durations. Valve driver 255 is a power circuit that converts TTL pulses 250 to the proper waveform 260 to open a valve in dispensing device 45. In this example, the waveform 260 is a 1 millisecond, 36-volt overdrive voltage followed by a 5.6-volt holding voltage (see FIG. 7, 200 and 205). The duration of this composite waveform approximates that of the TTL pulse 250 from the timing circuit 245.

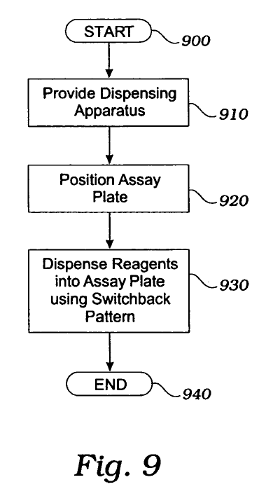

A personal computer (PC) 265 of a type well known in the art is programmed to download 3,456 valve open times to the FIFO in the timing circuit 245. PC 265 communicates with motion controller 235 via a standard Ethernet connection 233, and instructs motion controller 235 to output a master trigger 240 every 1.5 millimeters. Microplate 60 is moved into the starting position, where the dispensing tip 35 is 1.5 millimeters away from the first target well (see also FIG. 8 diagram A). PC 265 then commands motorized stage 225b to move down one row of 72 wells, during which 73 dispensations occur. Motorized stage 225a moves over 1.5 millimeters and motorized stage 225b moves up the next row. All target wells 55 of the 3,456-well microplate are thus filled as the microplate moves in this switchback pattern under the dispensing tip array 40.

The hardware referenced in FIG. 7 is well-known in the art and commercially available. For example, PC 265 may be a DELL PC with a DIO-96 Card 210, using Windows OS and running LabView control software available from National Instruments Corp. Motion controller 235 may be a Compumotor 6K2 motion controller available from Parker-Compumotor Corp. Timing Circuit 245 is available from Vertex Pharmaceuticals (San Diego) LLC, or may be manufactured using simple logic circuits to execute the desired functions described herein. Valve driver 255 may be 1NKX0505450AA available from The Lee Co. Motor drives 65 may be Zeta4 drives available from Parker-Compumotor Corp. Linear encoder 232 may be a Renishaw RGH22 available from Renishaw plc.

Turning now to FIG. 8, a preferred reagent dispensing pattern in accordance with present invention is illustrated. A 2×2 dispensing tip array 40 is shown, in which dispensing tips referred to herein previously as 35, are referred to in FIG. 8 specifically as d1, d2, d3, and d4. FIG. 8 includes ten separate diagrams (A through J), each representing a corresponding point in time during operation of the dispensing pattern in which the position of microplate 60 relative to dispensing tip array 40 progresses accordingly. These positions are referred to herein as positions A-J, respectively.

The rows of microplate 60 are referred to consecutively as row A, row B, . . . row Z and the columns are referred to consecutively as column 1, column 2, . . . column n, where “Z” represents the last row and “n” represents the last column. A particular well is thus referred to by the row-column intersection of the well. For example, well B1 represents the well at row B and column 1, and well Dn represents the well at row D and column n. Diagram A illustrates border area 95, raised skirt 100, rows A-Z, and columns 1-n. For the sake of simplicity, diagrams B-J are limited to only rows A and B, and do not include border area 95 or raised skirt 100.

Movement of microplate 60 is described with reference to FIG. 8 as horizontal and vertical. Such terms are used to refer to horizontal and vertical movement in the X-Y plane, wherein horizontal movement is along the X-axis (i.e., along rows) and vertical movement is along the Y-axis (i.e., columns). Such movement may be referred to herein in terms of units, in which one unit represents the well-to-well center spacing between two adjacent wells. The numbers of rows and columns is variable depending on the particular microplate 60 being used.

During operation as described herein, tip array 40 remains stationary, and microplate 60 is guided in a substantially continuous switchback pattern in an X-Y plane beneath tip array 40 until all specified wells 55 receive the desired reagents from dispensing tips d1-d4. Generally, the switchback pattern involves: 1) movement of microplate 60 horizontally in a first direction until all target wells 55 aligned with dispensing tips d1-d4 during the horizontal movement receive reagents from the dispensing tips d1-d4; 2) movement of the microplate 60 vertically one unit; 3) movement of microplate 60 horizontally in a direction opposite of the first horizontal direction, until all specified target wells 55 aligned with dispensing tips d1-d4 during the horizontal movement receive reagents from the dispensing tips d1-d4; 4) movement of the microplate 60 vertically one unit again in the same direction; 5) repeat of steps 1-4 as needed until all specified target wells 55 receive all desired reagents. The term switchback thus refers to the alternating horizontal movements in opposite directions during the dispensing pattern.

In some switchback patterns, one or more of the vertical movements of microplate 60 may be for more than one unit. This may be desirable, for example, if the dispensing algorithm requires one or more rows to be skipped during dispensation of one or more reagents 50. In such situations, the target wells 55 for the particular reagent or reagents 50 would not include those wells 55 in the skipped row. Such switchback patterns are referred to herein as row-skipping patterns.

Appropriately adjusted switchback patterns are preferably used for rectangular arrays of microtips larger than 2×2. And such adjusted switchback patterns can be further modifies to incorporate row or column skipping in a manner analogous to that described above for the 2×2 microtip array.

In the present invention, the switchback pattern may be combined with on-the-fly dispensing. On-the-fly dispensing is a much faster alternative to the stop-and-go dispensing method. On-the-fly reagent dispensing requires either microplate 60 or dispensing tip array 40 to move substantially continuously while dispensing tip array 40 or microplate 60, respectively, remains stationary, or both the microplate 60 and dispensing tip array 40 may move substantially continuously. On-the-fly dispensing is described herein as substantially continuous, because at times, movement of microplate 60 may temporarily stop. Most notably, this occurs when a change of direction is required. During movement of microplate 60 after acceleration and before deceleration, the speed of microplate 60 is preferably substantially constant.

Preferably, motor drive system 65 moves microplate 60 in a substantially continuous switchback pattern beneath dispensing tip array 40, during which time reagents 50 are dispensed through dispensing tips d1-d4 into target wells 55 of the microplate 60 in accordance with a timing algorithm synchronized to the switchback pattern and dependent on the assay plate geometry, the dispensing tip geometry, and the desired volumes of reagents 50 to be placed into wells 55. The motor drive system 65 is controlled by computer software, as is the timing algorithm which controls the dispensing devices 45. The timing algorithm is described in more detail in conjunction with FIG. 6 herein.

Referring still to FIG. 8, a preferred switchback dispensing pattern will be explained in more detail, using a 2×2 tip array 40 in which the tips are each specifically referred to as d1-d4 respectively for convenience. For illustrative purposes only, a microplate 60 having 3,456 wells is used, in which the well-to-well center spacing is 1.5 millimeters. Likewise, the distance between centers of tips d1 and d2, d1 and d4, d2 and d3, and d3 and d4, are each 1.5 millimeters. Other assay plates, including 96-well plates, 385-well plates, and 1,536-well plates, and other tip arrays, may be used in accordance with the present invention, in which case the timing algorithm and switchback pattern would be adjusted accordingly. In such instances, the dispensing tips would preferably be arranged geometrically such that the centers thereof are separated by distances corresponding to relevant dimensions of the particular assay plate being used therewith.

It should also be noted that the same reagent may be dispensed through each dispensing tip d1-d4. Alternatively, various reagent combinations may be dispensed through dispensing tips d1-d4 allowing for various ratios of reagents to be dispensed into plate wells 55. For example, dispensing tips d1-d3 may dispense reagent R1, and dispensing tip d4 may dispense a different reagent R2. After dispensing of reagents in equal amounts from each dispensing tip d1-d4 into a well 55, the well 55 would contain a 3:1 ratio of R1 to R2. On the other hand, dispensing tips d1-d4 may dispense 4 different reagents R1-R4 respectively. The 2×2 geometric arrangement thus allows for dispensing of up to 4 different reagents substantially simultaneously into 4 corresponding assay plate wells 55 in a highly efficient manner, as described herein. For the following example, each tip d1-d4 is used to dispense a different reagent R1-R4 respectively, with the understanding that any of R1-R4 may be the same reagent as any of the other R1-R4.

The process begins by positioning microplate 60 in a starting position A (see diagram A) relative to tip array 40 in preparation for dispensing the reagents. This starting position corresponds to FIG. 6A. Note the 2×2 arrangement of tip array 40 allows safe positioning of the tip array 40 in border area 95 of microplate 60, without contacting raised skirt 100. The left edge of tip d1 is positioned 1.5 millimeters from the left edge of well A1, such that horizontal movement of microplate 60 a distance of 1.5 millimeters towards tip array 40, tip d1 is aligned with well A1 and dispensing of R1 through tip d1 into well A1 may begin. The total dispensing time is calculated according to a timing algorithm as described, for example, in conjunction with FIG. 6.

The ability to position tip array 40 in border area 95 facilitates the switchback pattern, as will be seen. Such a pattern would not be feasible using, for example, a 48-tip linear array, without separating the microplate 60 from the tip array by an undesirable distance which tends to cause further dispensing problems. The initial position A shows the entire tip array 40 in border area 95. However, the initial position could also be position B (see diagram B), in which the first column (column 1) of microplate 60 is aligned with a column of tip array 40 consisting of tips d1 and d4. In such a case, dispensing would occur prior to the initial horizontal movement of 1.5 millimeters. In this regard, it should be noted that since the border area 95 could accommodate two columns of tips, and a third column could be positioned in alignment with a column of plate 60, a 3-column tip array could be used, if initial position A, as well as analogous positions within the switchback pattern, are avoided.

After initial positioning, reagents R1-R4 are then dispensed through corresponding tips d1-d4 into target wells 55 on microplate 60 in a switchback pattern such that each of the corresponding reagents R1-R4 is dispensed into each of the target wells 55. The first dispensing occurs at position B. In this position, tip d1 is aligned with well A1, and the remaining tips d2, d3, and d4 are within border area 95. Thus, reagent R1 is dispensed through tip d1 into well A1.

Once microplate 60 passes position B, the next dispensing position is position C. In this position, tip d1 is aligned with well A2, tip d2 is aligned with well A1, and the remaining tips d3 and d4 are within border area 95. Thus, reagent R1 is dispensed through tip d1 into well A2, and reagent R2 is dispensed through tip d2 into well A1, substantially simultaneously. Horizontal movement of microplate 60 in this initial direction (indicated as right-to-left in this example by arrow 57) continues, with dispensing of reagents R1 and R2 through tips d1 and d2 respectively, into wells A3 and A2 respectively, then wells A4 and A3 respectively all the way through wells An and A(n-1) respectively.

Once microplate 60 passes the position in which tips d1 and d2 are aligned with wells An and A(n-1) respectively, the next dispensing position is position D. In this position, tip d2 is aligned with well An, and the remaining tips d1, d3, and d4 are within border area 95. Thus, reagent R2 is dispensed through tip d2 into well An. At this point, reagents R1 and R2 have been dispensed into each well A1-An of the first row, row A. Other than the initial and final aforementioned dispensing positions, each dispensing step included dispensing of both reagents R1 and R2 substantially simultaneously, thus reducing significantly the overall dispensing time as compared to using a single dispensing tip.

At this point, microplate 60 may be stopped from moving left-to-right horizontally along the first row, and moved one unit up vertically, to result in position G. Alternatively, microplate 60 may be stopped from moving along the first row after movement of one additional horizontal unit to position E. In position E, dispensing tips d1-d4 are all positioned in the border area 95 such that the right edge of tip d2 is approximately 1.5 millimeters from the right edge of well An. As noted previously, in position E, the compact geometric arrangement of the 2×2 dispensing tip array 40 is designed to avoid contact with the raised skirt 100. If position E is reached, microplate 60 is then moved one unit vertically to position F, after which microplate 60 is then moved horizontally in the opposite direction (indicated as left-to-right in this example by arrow 59) to arrive at position G. Thus, position G may be arrived at either directly from position D, or by passing through positions E and F first. As previously described, using the direct D-to-G pattern would allow for a third column in tip array 40, because only two columns at any given position would occupy border area 95, and thus the skirt 100 may still be avoided. Either pattern may be used, and the timing algorithm may be adjusted accordingly.

At position G, tip d2 is aligned with well Bn, tip d3 is aligned with tip An, and the remaining tips d1 and d4 are within border area 95. Thus, reagent R2 is dispensed through tip d2 into well Bn, and reagent R3 is dispensed through tip d3 into well An, substantially simultaneously.

Once microplate 60 passes position G, the next dispensing position is position H. In this position, tip d1 is aligned with well Bn, tip d2 is aligned with well B(n-1), tip d3 is aligned with well A(n-1), and tip d4 is aligned with well An. Thus, reagent R1 is dispensed through tip d1 into well Bn, reagent R2 is dispensed through tip d2 into well B(n-1), reagent R3 is dispensed through tip d3 into well A(n-1), and reagent R4 is dispensed through tip d4 into well An, substantially simultaneously. Thus, corresponding reagents from first, second, third, and fourth dispensing tips (d1-d4) are dispensed into first, second, third, and fourth target wells respectively, substantially simultaneously. Horizontal movement of microplate 60 continues in this direction (see arrow 59), with dispensing of reagents R1-R4 through tips d1-d4 respectively, into wells B(n-1), B(n-2), A(n-2), and A(n-1) respectively, then wells B(n-2), B(n-3), A(n-3), and A(n-2) respectively, all the way through wells B2, B1, A1, and A2 respectively.

Once microplate 60 passes the position in which tips d1-d4 are aligned with wells B2, B1, A1, and A2 respectively, the next dispensing position is position I. In this position, tip d1 is aligned with well B1, tip d4 is aligned with well A1, and the remaining tips d2 and d3 are within border area 95. Thus, reagent R1 is dispensed through tip d1 into well B1, and reagent R4 is dispensed through tip d4 into well A1. At this point, reagents R1, R2, R3, and R4 have been dispensed into each well A1-An of the first row, row A. Only reagents R1 and R2 have been dispensed into each well B1-Bn of the second row, row B.

As discussed previously with reference to consecutive positions D and E when plate 60 was moving right-to-left, here similarly the next position after position I may be position J, after which plate 60 would be moved up one unit (to a position not shown) in preparation for switching back to right-to-left movement. Alternatively, and as discussed previously with reference to consecutive positions D and G when plate 60 was moving right-to-left, here similarly plate 60 could be moved up one unit from position I, in preparation for switching back to right-to-left movement, bypassing position J and the subsequent position (not shown).

For the initial and final aforementioned dispensing positions during horizontal movement of microplate 60 in the left-to-right direction indicated by arrow 59, each dispensing step included dispensing of two reagents substantially simultaneously (R2 and R3 at position G, and R1 and R4 at position I). For the remaining aforementioned dispensing positions during horizontal movement of microplate 60 in the left-to-right direction indicated by arrow 59, each dispensing step included substantially simultaneous dispensing of all four reagents R1-R4. Again, the overall dispensing time is significantly reduced as compared to using a single dispensing tip.

The dispensing pattern as shown in diagrams F through J (or G through I) then repeats in a switchback manner, with microplate 60 alternating right-to-left then left-to-right movement one row at a time, during which reagents R3 and R4 are dispensed into rows B-Y, and reagents R1 and R2 are dispensed into rows C through Z respectively. One additional switchback is then performed to dispense reagents R3 and R4 into row Z. Thus, dispensing using a switchback pattern as described herein results in a large percentage of the individual dispensations occurring through all four tips d1-d4 substantially simultaneously, reducing overall dispensing time significantly. Conducting the switchback pattern on-the-fly further reduces overall dispensing time.

As previously described, motor drive system 65 moves microplate 60 in the switchback pattern, and a computer-program-controlled electronic trigger 240 is provided to open dispensing devices 45 for appropriate time intervals such that desired amounts of reagents 50 are dispensed into corresponding target wells 55 of microplate 60. The time intervals are less than the time required for the target wells to move past the corresponding dispensing tips. (See FIG. 6 and discussion thereof, for a more detailed description.) The timing algorithm should be synchronized to the switchback pattern, and dependent on geometric characteristics of the assay plate (for example, the border area, the raised skirt, the well-to-well center distances, and the number of wells), volumes of the corresponding reagents to be dispensed, and geometric characteristics of the dispensing tip array (for example center-to-center distances, and the size of tip openings). For example, the tip array geometry should be such that each tip may be aligned with each target well at some point during the dispensing pattern so that each of the corresponding reagents may be dispensed into each of the target wells. It should be understood, however, that the present invention does not require that each reagent be dispensed into each and every well 55, and that a user may specify which reagents, or none at all, are to be dispensed into each well 55.

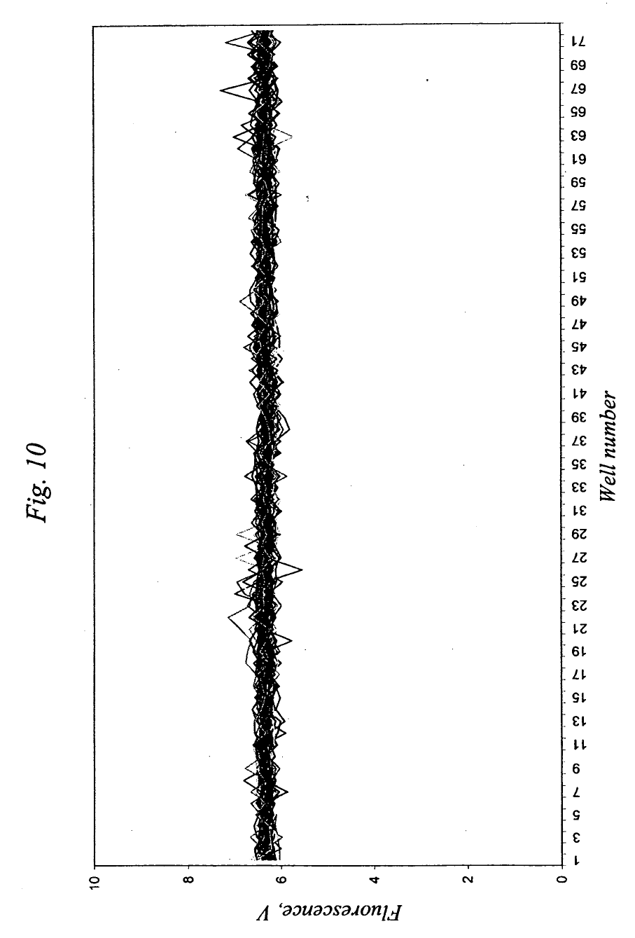

Also, the distances between centers of the dispensing tips may be calculated to correspond to the timing algorithm associated with a microplate having known dimensions. For example, the distance between the centers of the dispensing tips in a single row of a 2×2 array could be approximately 1.50 millimeters, approximately 2.25 millimeters, or approximately 4.50 millimeters. Turning now to FIG. 9, a simple flow chart illustrating a preferred method of the present invention is shown. The process begins at 900. At step 910, a reagent dispensing apparatus as described herein is provided. In this respect, “providing” the apparatus is intended to refer to the fact that such an apparatus is in fact present in use with the method, and so the apparatus may be provided by the actual user thereof. Alternatively, a third party manufacturer, distributor, or other third party may supply the apparatus.

At step 920, the assay plate is then positioned relative to dispensing tip array 40 in preparation for dispensing the reagents. The actual position of the assay plate relative to the dispensing tips will vary depending upon various factors including the dimensions and geometric properties of the assay plate, height of dispensing tips, geometric arrangement of the dispensing tips, and the switchback pattern(s) and timing algorithm(s) being used in operation of the apparatus for a particular use.

At step 930, the apparatus dispenses the corresponding reagents through the corresponding tips into target wells on the assay plate in a switchback pattern such that each of the corresponding reagents is dispensed into each of the target wells. This is described in more detail in conjunction with FIG. 8. In the preferred embodiment, movement of the assay plate in a switchback pattern is conducted on-the-fly by substantially continuous movement of the assay plate accomplished by a motor drive system controlled by computer software. Though on-the-fly reagent dispensing requires either the microplate, the reagent dispensing device, or both to move substantially continuously, the switchback pattern may involve brief stops of the continuous movement due to changes in direction along the X-axis and/or Y-axis as defined by the pattern itself. The process ends at step 940.

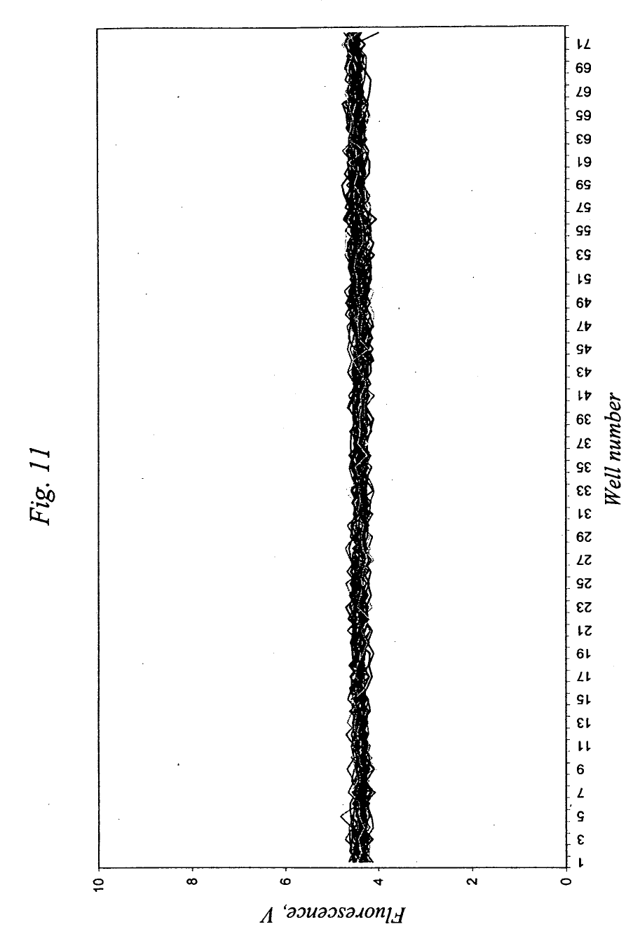

Turning now to FIGS. 10 and 11, experimental data illustrates the reagent dispensing accuracy and precision of the 2×2 array 40 of the present invention. In a control experiment, 2.3 microliter samples of Carboxy-Fluorescein were dispensed into the 3,456 wells of a microplate using a one-tip dispenser in order to establish a baseline coefficient of variation (CV). In the control experiment, the CV across the entire plate was 2.3%. The results are seen in the graph of FIG. 10. In a second experiment, samples made up of 0.3 microliters of Carboxy-Fluorescein and four times 0.5 microliters of buffer were dispensed into a microplate. With a total of five dispensations per well, the CV across the entire plate was less than approximately 2.6%. The motorized stage 225 moved at thirty-five millimeters per second, and the entire microplate was filled in approximately three minutes. The results of the second experiment are seen in the graph of FIG. 11. The two aforementioned experiments demonstrate that using short discrete fluid paths and corresponding discrete dispensing tips 35 for corresponding reagents 50, results in excellent reproducibility of the volumes dispensed across the entire microplate 60. The CV of reagent concentrations across all wells of a microplate after dispensing of reagents using the reagent dispensing apparatus and method as described herein is less than approximately 10.0%, and more preferably less than approximately 5.0%, and more preferably less than approximately 2.6%.

While certain embodiments are illustrated in the drawings and are described herein, including preferred embodiments, it will be apparent to those skilled in the art that the specific embodiments described herein may be modified without departing from the inventive concepts described. Accordingly, Applicants' invention as described herein is not to be restricted, except in accordance with the law by the claims which follow.

1. A reagent dispensing apparatus comprising:
a support frame; and
a dispensing module removably attached to the support frame and comprising a self-contained pressurized fluid delivery subsystem;
wherein the fluid delivery subsystem comprises a plurality of reagent containers each being fluidly connected to a corresponding discrete fluid path terminating in a corresponding discrete dispensing tip, said dispensing tips being collectively arranged in a rectangular array, each fluid path having a corresponding dispensing device, each dispensing device being adapted to selectively dispense a corresponding reagent through the corresponding dispensing tip in response to a corresponding actuation signal.

2. The apparatus of claim 1, wherein the rectangular array comprises two or more dispensing tips.

3. The apparatus of claim 2, wherein distances between centers of the dispensing tips are calculated to correspond to a timing algorithm associated with an assay plate having known dimensions.

4. The apparatus of claim 3, wherein the distance between the centers of adjacent dispensing tips is approximately 1.50 millimeters.

5. The apparatus of claim 3, wherein the distance between the centers of adjacent dispensing tips is approximately 2.25 millimeters.

6. The apparatus of claim 3, wherein the distance between the centers of adjacent dispensing tips is approximately 4.50 millimeters.

7. The apparatus of claim 1, wherein the pressurized fluid delivery subsystem further comprises an air manifold with a port for receiving an air supply line from a source of pressurized air, and a plurality of air delivery lines extending from the air manifold, wherein each of the plurality of air delivery lines is connected to a corresponding one of the plurality of reagent containers.

8. The apparatus of claim 1, wherein each fluid path is less than approximately 25 centimeters in length.

9. The apparatus of claim 1, wherein each fluid path has a volume capacity of less than approximately 200 microliters.

10. The apparatus of claim 1, wherein each dispensing device comprises corresponding electrical leads for receiving the corresponding actuation signals.

11. The apparatus of claim 10, wherein the actuation signals are controlled by computer software.

12. The apparatus of claim 1, wherein each dispensing device comprises a corresponding solenoid.

13. The apparatus of claim 1, wherein the dispensing module is attached to the support frame using quick-release clamps.

14. The apparatus of claim 1, further comprising a motor drive system for controlling movement of an assay plate.

15. The apparatus of claim 1, wherein the coefficient of variation of reagent concentration within wells of an assay plate after dispensing of reagents thereinto using the apparatus is less than approximately 2.6%.

16. The apparatus of claim 1, wherein the coefficient of variation of reagent concentration within wells of an assay plate after dispensing of reagents thereinto using the apparatus is less than approximately 5.0%.

17. The apparatus of claim 1, wherein the coefficient of variation of reagent concentration within wells of an assay plate after dispensing of reagents thereinto using the apparatus is less than approximately 10.0%.

18. The apparatus of claim 1, wherein the fluid paths each comprise a corresponding portion supported by a common dispensing head.

19. A reagent dispensing module adapted to be removably attached to a support frame, comprising:
means for removably attaching the dispensing module to the support frame;
a platform;
a plurality of reagent containers supported by the platform, each of the plurality of reagent containers being fluidly connected to a corresponding discrete fluid path terminating in a corresponding discrete dispensing tip, the dispensing tips being collectively arranged in a rectangular array, each fluid path having a corresponding dispensing device for controlling selective dispensing of a corresponding reagent through the corresponding dispensing tip in response to a corresponding electrical signal;
an air manifold with a port for receiving an air supply line from a source of pressurized air; and
a plurality of air delivery lines connected to the air manifold, each of the plurality of air delivery lines being connected to a corresponding one of the plurality of reagent containers.

20. The module of claim 19, wherein the rectangular array comprises two or more dispensing tips.

21. The module of claim 20, wherein distances between centers of the dispensing tips are calculated to correspond to a timing algorithm associated with an assay plate having known dimensions.

22. The module of claim 21, wherein the distance between the centers of adjacent dispensing tips is approximately 1.50 millimeters.

23. The module of claim 21, wherein the distance between the centers of adjacent dispensing tips is approximately 2.25 millimeters.

24. The module of claim 21, wherein the distance between the centers of adjacent dispensing tips is approximately 4.50 millimeters.

25. The module of claim 19, wherein each fluid path is less than approximately 25 centimeters in length.

26. The module of claim 19, wherein each fluid path has a volume capacity of less than approximately 200 microliters.

27. The module of claim 19, wherein each dispensing device comprises corresponding electrical leads for receiving the corresponding electrical signals.

28. The module of claim 27, wherein the electrical signals are controlled by computer software.

29. The module of claim 19, wherein each dispensing device comprises a corresponding solenoid.

30. The module of claim 19, wherein the means for removably attaching the dispensing module to the support frame comprises quick-release clamps.

31. The module of claim 19, further comprising a motor drive system for controlling movement of an assay plate.

32. The module of claim 19, wherein the coefficient of variation of reagent concentration within wells of an assay plate after dispensing of reagents thereinto using the module is less than approximately 2.6%.

33. The module of claim 19, wherein the coefficient of variation of reagent concentration within wells of an assay plate after dispensing of reagents thereinto using the module is less than approximately 5.0%.

34. The module of claim 19, wherein the coefficient of variation of reagent concentration within wells of an assay plate after dispensing of reagents thereinto using the module is less than approximately 10.0%.

35. The module of claim 19, wherein the fluid paths each comprise a corresponding portion supported by a common dispensing head.

36. A reagent dispensing head for use with a reagent dispensing apparatus, comprising:
a plurality of discrete fluid tubes each comprising a corresponding dispensing device for selectively dispensing corresponding reagents at corresponding dispensing tips arranged in a rectangular array, each fluid tube being connected to a corresponding discrete fluid delivery line associated with a corresponding discrete reagent container; and
a common support block for supporting the fluid tubes;
wherein the dispensing devices each comprise corresponding electrical leads for receiving corresponding electrical signals to control dispensing of corresponding reagents through the corresponding dispensing tips.

37. The dispensing head of claim 36, wherein the dispensing devices comprise corresponding solenoids.

38. The dispensing head of claim 36, wherein the rectangular array comprises two or more dispensing tips.

39. The dispensing head of claim 38, wherein distances between centers of the dispensing tips are calculated to correspond to a timing algorithm associated with an assay plate having known dimensions.

40. The dispensing head of claim 39, wherein the distance between the centers of adjacent dispensing tips is approximately 1.50 millimeters.

41. The dispensing head of claim 39, wherein the distance between the centers of adjacent dispensing tips is approximately 2.25 millimeters.

42. The dispensing head of claim 39, wherein the distance between the centers of adjacent dispensing tips is approximately 4.50 millimeters.

43. The dispensing head of claim 36, further comprising protective sleeves covering corresponding portions of the fluid tubes.

44. A method of dispensing reagents comprising the steps:
providing a reagent dispensing apparatus comprising: a support frame; and a dispensing module comprising a self-contained pressurized fluid delivery subsystem; wherein the fluid delivery subsystem comprises a plurality of reagent containers each being fluidly connected to a corresponding discrete fluid path terminating in a corresponding discrete dispensing tip, said dispensing tips being collectively arranged in a rectangular array, each fluid path having a corresponding dispensing device for controlling selective dispensing of a corresponding reagent through the corresponding dispensing tip in response to a corresponding electrical signal;
positioning an assay plate in a starting position relative to the dispensing tips in preparation for dispensing the reagents; and
dispensing the corresponding reagents through the corresponding dispensing tips into target wells on the assay plate in a switchback pattern such that each of the corresponding reagents is dispensed into each of the target wells.

45. The method of claim 44 wherein the dispensing step is conducted on-the-fly.

46. The method of claim 45, wherein the reagents are dispensed through the corresponding dispensing tips in accordance with a timing algorithm synchronized to the switchback pattern and dependent on geometric characteristics of the assay plate, volumes of the corresponding reagents to be dispensed, and geometric characteristics of the dispensing tip array.

47. The method of claim 44 wherein the pressurized fluid delivery subsystem further comprises an air manifold with a port for receiving an air supply line from a source of pressurized air, and a plurality of air delivery lines extending from the air manifold, wherein each of the plurality of air delivery lines is connected to a corresponding one of the plurality of reagent containers, and further comprising the step of supplying pressurized air into each of the reagent containers via the corresponding air delivery lines substantially continuously during the dispensing step.

48. The method of claim 44, wherein the dispensing devices comprise corresponding solenoids.

49. The method of claim 44, wherein the rectangular array comprises two or more dispensing tips.

50. The method of claim 44, wherein the rectangular array is a 2×2 array and comprises a first dispensing tip, a second dispensing tip, a third dispensing tip, and a fourth dispensing tip, and wherein the target wells comprise a first target well, a second target well, a third target well, and a fourth target well, and wherein the dispensing step further comprises dispensing the corresponding reagents from the first, second, third, and fourth dispensing tips into the first, second, third, and fourth target wells respectively, substantially simultaneously.

51. The method of claim 49, wherein distances between centers of the dispensing tips are calculated to correspond to a timing algorithm associated with an assay plate having known dimensions.

52. The method of claim 51, wherein the distance between the centers of adjacent dispensing tips is approximately 1.50 millimeters.

53. The method of claim 51, wherein the distance between the centers of adjacent dispensing tips is approximately 2.25 millimeters.

54. The method of claim 51, wherein the distance between the centers of adjacent dispensing tips is approximately 4.50 millimeters.

55. The method of claim 44, wherein the assay plate is moved in the switchback pattern by a motor drive system controlled by computer software.

56. The method of claim 44, wherein the coefficient of variation of reagent concentration within wells of an assay plate after dispensing of the reagents thereinto using the apparatus is less than approximately 2.6%.

57. The method of claim 44, wherein the coefficient of variation of reagent concentration within wells of an assay plate after dispensing of the reagents thereinto using the apparatus is less than approximately 5.0%.

58. The method of claim 44, wherein the coefficient of variation of reagent concentration within wells of an assay plate after dispensing of the reagents thereinto using the apparatus is less than approximately 10.0%.

59. The method of claim 44, wherein the switchback pattern is a row-skipping pattern.

60. Computer software for controlling a reagent dispensing apparatus comprising: a support frame; and a dispensing module comprising a self-contained pressurized fluid delivery subsystem; wherein the fluid delivery subsystem comprises a plurality of reagent containers each being fluidly connected to a corresponding discrete fluid path terminating in a corresponding discrete dispensing tip, said dispensing tips being collectively arranged in a rectangular array, each fluid path having a corresponding dispensing device for controlling selective dispensing of a corresponding reagent through the corresponding dispensing tip in response to a corresponding electrical signal; said software being programmed to:
position an assay plate in a starting position relative to the dispensing tips in preparation for dispensing the reagents; and
dispense the corresponding reagents through the corresponding tips into target wells on the assay plate in a switchback pattern such that each of the corresponding reagents is dispensed into each of the target wells.

61. The software of claim 60, further programmed to conduct the dispensing step is on-the-fly.

62. The software of claim 61, further programmed to dispense the reagents through the corresponding dispensing tips in accordance with a timing algorithm synchronized to the switchback pattern and dependent on geometric characteristics of the assay plate, volumes of the corresponding reagents to be dispensed, and geometric characteristics of the dispensing tip array.

63. The software of claim 60, wherein the rectangular array comprises two or more dispensing tips.

64. The software of claim 63, wherein the rectangular array comprises a first dispensing tip, a second dispensing tip, a third dispensing tip, and a fourth dispensing tip, and wherein the target wells comprise a first target well, a second target well, a third target well, and a fourth target well, and wherein the software is further programmed to dispense the corresponding reagents from the first, second, third, and fourth dispensing tips into the first, second, third, and fourth target wells respectively, substantially simultaneously.

65. The software of claim 63, wherein the distance between the centers of adjacent dispensing tips is approximately 1.50 millimeters.

66. The software of claim 63, wherein the distance between the centers of adjacent dispensing tips is approximately 2.25 millimeters.

67. The software of claim 63, wherein the distance between the centers of adjacent dispensing tips is approximately 4.50 millimeters.

68. The software of claim 60, further programmed to control a motor drive system to move the assay plate in the switchback pattern.

69. The software of claim 60, wherein the coefficient of variation of reagent concentration within wells of an assay plate after dispensing of the reagents thereinto using the apparatus controlled by the software is less than approximately 2.6%.

70. The software of claim 60, wherein the coefficient of variation of reagent concentration within wells of an assay plate after dispensing of the reagents thereinto using the apparatus controlled by the software is less than approximately 5.0%.

71. The software of claim 60, wherein the coefficient of variation of reagent concentration within wells of an assay plate after dispensing of the reagents thereinto using the apparatus controlled by the software is less than approximately 10.0%.
